(19) United States
(12) Patent Application Publication
(10) Pub. No.: US 2022/0148108 A1
(43) Pub. Date: May 12, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yasuhiro HAYASHI, Mitaka-shi (JP); Kazunori FUJIMORI, Nagoya-shi (JP); Takuji YAMADA, Musashino-shi (JP); Naoya OKA, Nagakute-shi (JP); Daisuke KIMURA, Toyota-shi (JP); Yumiko YAMASHITA, Nagoya-shi (JP)

(73) Assignee: TOYOTA JIDOSHA KABUSHIKI KAISHA, Toyota-shi (JP)

(21) Appl. No.: 17/452,254

(22) Filed: Oct. 26, 2021

(30) Foreign Application Priority Data
Nov. 10, 2020 (JP) 2020-187144

(51) Int. Cl. G06Q 50/14; G06Q 10/06

(52) U.S. Cl. CPC G06Q 50/14; G06Q 10/0631

(57) ABSTRACT

An information processing apparatus comprises a controller configured to: generate a plurality of movement plans for touring around a plurality of spots; acquire, for each of the plurality of spots included in each of the plurality of movement plans, spot information that is information that affects a level of satisfaction of a user visiting the spot; and present, to the user, each of the plurality of movement plans together with the spot information about each of the plurality of spots.

### CROSS REFERENCE TO THE RELATED APPLICATION

This application claims the benefit of Japanese Patent Application No. 2020-187144, filed on Nov. 10, 2020, which is hereby incorporated by reference herein in its entirety.

### BACKGROUND

### Technical Field

The present disclosure relates to a schedule generation technology.

### Description of the Related Art

There are technologies for making proposals at tourist sites and the like for touring around a plurality of spots.

For example, Japanese Patent Laid-Open No. 2018-142250 discloses a system that proposes a plurality of visiting spots that match preference of a user. With this system, spots to be visited and a touring route therefor may be generated based on a departure point, an arrival point, a required time and the like input by the user.

### SUMMARY

The system described above may generate a combination of a plurality of spots, and a touring schedule therefor. However, this system evaluates spots based on how much they are worth visiting by a user, and does not estimate a level of satisfaction the user can get by actually visiting the spots.

Accordingly, for example, even in a case where there is a spot that becomes crowded in a specific time slot (such as lunchtime) and the level of satisfaction of the user is increased if such a time slot is avoided, a proposal to the effect cannot be made.

The present disclosure has been made in view of the problem described above, and is aimed at increasing the level of satisfaction of a user in a system that generates a plan for touring around a plurality of spots.

The present disclosure in its one aspect provides An information processing apparatus comprising a controller configured to: generate a plurality of movement plans for touring around a plurality of spots; acquire, for each of the plurality of spots included in each of the plurality of movement plans, spot information that is information that affects a level of satisfaction of a user visiting the spot; and present, to the user, each of the plurality of movement plans together with the spot information about each of the plurality of spots.

The present disclosure in its another aspect provides an information processing method comprising: generating a plurality of movement plans for touring around a plurality of spots; acquiring, for each of the plurality of spots included in each of the plurality of movement plans, spot information that is information that affects a level of satisfaction of a user visiting the spot; and presenting, to the user, each of the plurality of movement plans together with the spot information about each of the plurality of spots.

Furthermore, another mode of the present disclosure is a program for causing a computer to perform the information processing method described above, or a non-transitory computer-readable storage medium storing the program.

According to the present disclosure, a level of satisfaction of a user may be increased in a system that generates a plan for touring around a plurality of spots.

### BRIEF DESCRIPTION OF THE DRAWINGS

FIG. 1 is a diagram for describing an outline of an information processing system;

FIG. 2 is a diagram illustrating in greater detail structural elements of the information processing system;

FIG. 3 is a schematic diagram for describing spot information that is stored in the system;

FIG. 4 is an example of a spot database in a first embodiment;

FIG. 5 is a flowchart of a process that is performed by a controller in the first embodiment;

FIG. 6 is an example of a movement plan that is generated;

FIG. 7 is an example of information about a level of crowdedness;

FIG. 8 is an example of an interface screen that is presented to a user in the first embodiment;

FIG. 9 is an example of a spot database in a second embodiment;

FIG. 10 is an example of an interface screen that is presented to a user in the second embodiment;

FIGS. 11A and 11B are example of information about a level of recommendation that is different based on a time slot;

FIG. 12 is an example of a spot database in a third embodiment; and

FIG. 13 is an example of an interface screen that is presented to a user in the third embodiment.

### DESCRIPTION OF THE EMBODIMENTS

An information processing apparatus according to an embodiment of the present disclosure is an apparatus that generates a plan (a schedule) for a user to tour around a plurality of spots at a tourist site or the like.

An existing apparatus of such a type tends to highly evaluate a plan for which a total of evaluation values associated with respective spots is great.

However, the state of a spot may change over time, and thus, a user actually visiting a spot cannot always get a high level of satisfaction. For example, in a case where a plan to arrive at a famous restaurant at lunchtime is generated, one is possibly turned away due to the restaurant being crowded. Furthermore, if a plan to visit, during daytime, a spot that is famous for night view is generated, a user cannot get satisfaction.

An information processing apparatus according to an embodiment copes with such a problem by focusing on a level of satisfaction of a user at a time of visiting a spot.

An information processing apparatus includes a controller configured to generate a plurality of movement plans for touring around a plurality of spots, acquire, for each of the plurality of spots included in each of the plurality of movement plans, spot information that is information that affects a level of satisfaction of a user visiting the spot, and present, to the user, each of the plurality of movement plans together with the spot information about each of the plurality of spots.

At the time of generating a plan, the controller acquires the spot information that is information that affects the level of satisfaction of the user visiting each spot, and presents, to the user, the spot information about each spot, together with the movement plan. For example, the spot information may be a level of crowdedness, an entrance wait time, a level of recommendation of visit, or the like at a time of arrival of the user.

According to such a configuration, information that affects the level of satisfaction, about each spot, may be presented to the user on a per-spot basis. Accordingly, the user may select a movement plan that is more to his/her liking.

Furthermore, the spot information may be information about characteristics of a corresponding spot that are different based on a time slot, and the controller may extract, from the spot information, information corresponding to an arrival time, for each of the plurality of spots included in each of the plurality of movement plans, and may present the information to the user.

Characteristics of a target spot are sometimes different for each time slot. For example, visitors may be few and touring may be easy in a certain time slot, and in another time slot, there may be many visitors and services may be hard to receive. Moreover, there may be a specific merit in visiting in a certain time slot. Accordingly, helpful information may be provided to the user by using information about characteristics in each time slot.

Additionally, the information processing apparatus may further include a storage configured to store each of the plurality of spots in association with the spot information.

Furthermore, the spot information may include information about a level of crowdedness that is different based on a time slot, and the controller may present, to the user, as the spot information, information indicating the level of crowdedness at a time of arrival at each of the plurality of spots.

Furthermore, the spot information may include information about a wait time that is different based on a time slot, and the controller may present, to the user, as the spot information, information indicating the wait time at a time of arrival at each of the plurality of spots.

Information indicating the level of crowdedness or the wait time may be expressed in number or by graph, for example. According to such a configuration, information for avoiding crowdedness may be provided to the user.

Furthermore, the spot information may include information about a level of recommendation of visit that is different based on a time slot, and the controller may present, to the user, as the spot information, information indicating the level of recommendation of visit at a time of arrival at each of the plurality of spots.

A time slot when visit is desirable may be set for each spot, such a time slot being a time slot when the spot is open, a time slot when a specific service can be received, or a time slot when a specific view (such as a night view) can be enjoyed, for example. Information that affects the level of satisfaction can thus be provided to the user by using the information about the level of recommendation of visit.

Furthermore, the information processing apparatus may further include a storage configured to store, for the plurality of spots, image data that is captured at each spot in each of different time slots, where the controller may acquire the image data corresponding to an arrival time, for each of the plurality of spots included in each of the plurality of movement plans, and may further present the image data to the user.

By presenting, to the user, image data that is captured in each time slot at an actual location, the user may get a concrete idea about each spot when the spot is visited according to a movement plan.

Furthermore, the controller may evaluate the plurality of spots based on preference of the user, and may further present a comment based on the evaluation to the user.

For example, preference of each user, such as “I want to go to cinema before restaurant”, is sometimes desirably reflected in the movement plan. A more suitable plan may be selected for the user by displaying a comment based on the preference of the user.

Furthermore, the controller may determine, based on the spot information that is acquired, that a spot for which the level of satisfaction of the user is below a predetermined value is included in at least one of the plurality of movement plans, and may propose, in relation to the spot, an alternative spot for which the level of satisfaction exceeds the predetermined value.

The alternative spot is desirably a spot with a similar attribute.

Furthermore, the controller may determine, based on the spot information that is acquired, that a spot for which the level of satisfaction of the user is below a predetermined value is included in at least one of the plurality of movement plans, and may refrain from presenting a movement plan including the spot to the user.

A movement plan including a spot where only a low level of satisfaction can be obtained may thus be excluded, for example.

In the following, specific embodiments of the present disclosure will be described with reference to the drawings. Hardware configurations, module configurations, functional configurations and the like described in each embodiment are not intended to limit the technical scope of the disclosure unless stated otherwise.

### First Embodiment

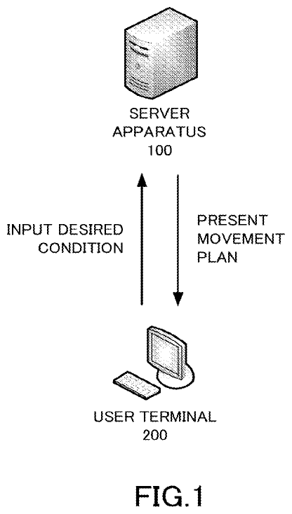

An outline of an information processing system according to a first embodiment will be described with reference to FIG. 1. The information processing system according to the present embodiment includes a server apparatus 100 that generates a plan (a schedule) for touring around a plurality of spots (such as tourist spots), and a user terminal 200.

The user terminal 200 is a computer owned by a user. The user is able to access the server apparatus 100 via the user terminal 200, and to request generation of a plan for touring around a plurality of spots. Additionally, the user may transmit desired conditions (such as a desired region, a desired attribute of a spot, a departure time and the like) to the server apparatus 100, together with the request.

The server apparatus 100 generates a plan for touring around a plurality of spots in a predetermined region, based on the request transmitted from the user terminal 200. Furthermore, at the time of presenting the plan, the server apparatus 100 presents, at the same time, information (spot information) that affects the level of satisfaction of the user visiting the plurality of spots included in the plan. The spot information is unique information about each spot, and may be information related to the level of crowdedness, information related to the level of recommendation of visit and the like, for example.

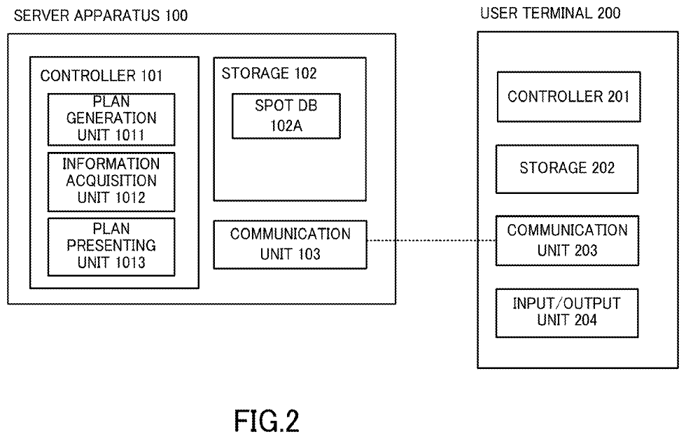

FIG. 2 is a diagram illustrating in greater detail structural elements of the information processing system according to the present embodiment. First, a description will be given of the user terminal 200.

For example, the user terminal 200 is a computer that is used by an individual, such as a personal computer, a smartphone, a mobile phone, a tablet computer, or a personal digital assistant. The user terminal 200 includes a controller 201, a storage 202, a communication unit 203, and an input/output unit 204.

The controller 201 is an arithmetic device that is in charge of control that is performed by the user terminal 200. The controller 201 may be implemented by an arithmetic processing device such as a central processing unit (CPU).

The controller 201 includes a function of accessing and interacting with the server apparatus 100. This function may be implemented by a web browser running on the user terminal 200.

The storage 202 includes a main memory and an auxiliary memory. The main memory is a memory where programs to be executed by the controller 201, and data to be used by the control programs are developed. The auxiliary memory is a device that stores the programs to be executed by the controller 201, and the data to be used by the control programs. The auxiliary memory may store the programs to be executed by the controller 201 in the form of packaged applications. An operating system for executing the applications may also be stored. Processes described later are performed by the programs stored in the auxiliary memory being loaded into the main memory and being executed by the controller 201.

The main memory may include a random access memory (RAM) and a read only memory (ROM). Furthermore, the auxiliary memory may include an erasable programmable ROM (EPROM) and a hard disk drive (HDD). The auxiliary memory may further include a removable medium, or in other words, a removable recording medium.

The communication unit 203 is a wireless communication interface for connecting the user terminal 200 to a network. For example, the communication unit 203 is capable of communicating with the server apparatus 100 and an EC server 300 by a wireless LAN or a mobile communication service such as 3G, LTE or 5G, for example.

The input/output unit 204 is a unit that receives an input operation performed by a user, and that presents information to the user, and is, in the present embodiment, one touch panel display, or in other words, a liquid crystal display and a control unit thereof, or a touch panel and a control unit thereof.

Next, a description will be given of the server apparatus 100.

The server apparatus 100 generates, based on a request transmitted from the user terminal 200, a plurality of plans for touring around a plurality of spots in a predetermined area, and presents the same to the user.

The server apparatus 100 may be a general-purpose computer. That is, the server apparatus 100 may be a computer that includes processors such as a CPU, a GPU and the like, main memories such as a RAM, a ROM and the like, and auxiliary memories such as an EPROM, a hard disk drive, a removable medium and the like. The removable medium may be a USB memory, or a disk recording medium such as a CD or a DVD, for example. The auxiliary memory stores an operating system (OS), various programs, various tables and the like, and each function matching a predetermined object as described later may be implemented by controlling each structural unit or the like through execution of a program stored in the auxiliary memory, by loading the program into a work area of the main memory and executing the same. However, the functions may be partially or wholly implemented by a hardware circuit such as an ASIC or an FPGA.

The controller 101 is an arithmetic device that is in charge of control that is performed by the server apparatus 100. The controller 101 may be implemented by an arithmetic processing device such as a CPU.

The controller 101 includes three functional modules, namely, a plan generation unit 1011, an information acquisition unit 1012, and a plan presenting unit 1013. Each functional module may be implemented by the CPU executing a program that is stored.

The plan generation unit 1011 generates, based on a request received from the user terminal 200 and information that is stored in a storage 102 described later, a plurality of plans (schedules) for touring around a plurality of spots in a predetermined area. Specifically, a user interface for interacting with the user is generated, and a plurality of movement plans are generated based on a request acquired via the user interface.

The request includes a departure point, a departure date/time, a spot visit to which is desired (if any), a genre of spot visit to which is desired, and a returning time, for example. The plan generation unit 1011 determines a plurality of spots to be proposed to the user, based on such information pieces, and generates a plurality of plans for touring around the spots.

The movement plan that is generated by the plan generation unit 1011 is generated based on existing evaluation criteria such as a movement cost and an evaluation of the spot itself, and does not take into account the level of satisfaction of the user. The plan generation unit 1011 transmits the plurality of movement plans that are generated, to the information acquisition unit 1012.

The information acquisition unit 1012 acquires spot information that is associated with each of a plurality of spots included in each of the plurality of movement plans that are generated. The spot information is information about characteristics of a spot that are different based on the time slot.

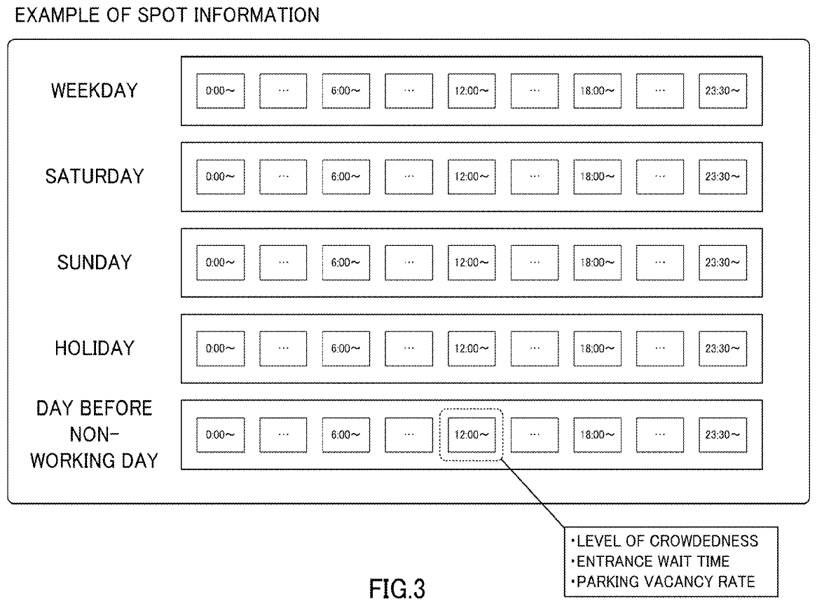

FIG. 3 is a diagram for describing the spot information. In the illustrated example, data about the level of crowdedness at a spot is defined for each day of the week and each time slot (in units of 30 minutes). In the present example, the level of crowdedness is cited as an example of the characteristics, but information other than the level of crowdedness may be used as the spot information as long as the information influences the level of satisfaction of the user. By acquiring such spot information and presenting the same to the user, the user may be informed of “the state of the spot when the user visits the spot”. Accordingly, the level of satisfaction that can be obtained at the spot may be indirectly indicated to the user.

The plan presenting unit 1013 presents the plurality of movement plans to the user, together with the spot information that is acquired. Specifically, a user interface including the schedule for touring around a plurality of spots, the spot information about each spot, an evaluation based on the spot information and the like is generated and output. A specific example will be described later.

The plan generation unit 1011 and the plan presenting unit 1013 may interact with the user terminal 200 by using an incorporated web server.

The storage 102 includes a main memory and an auxiliary memory. The main memory is a memory where programs to be executed by the controller 101, and data to be used by the control programs are developed. The auxiliary memory is a device that stores the programs to be executed by the controller 101, and the data to be used by the control programs.

The storage 102 further stores a spot database 102A.

The spot database 102A is a database that stores the spot information described above. The spot database 102A stores, in association with each other, information about a plurality of spots, and the spot information about respective spots.

The spot database 102A is structured by managing data stored in a memory by a program of a database management system (DBMS) that is executed by the processor. The spot database 102A is a relational database, for example.

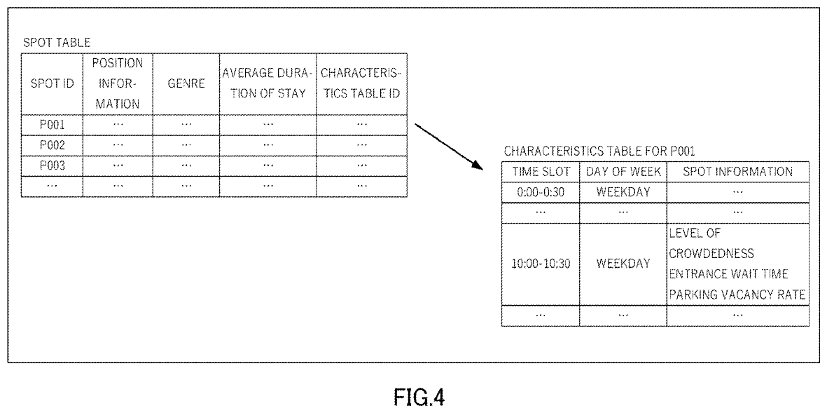

A specific example of the spot database 102A will be described with reference to FIG. 4. FIG. 4 is a diagram illustrating an example of data that is stored in the spot database 102A. The spot database 102A includes a spot table and a characteristics table.

The spot table stores information about a plurality of spots. Specifically, an identifier of a spot, position information, a genre, an average duration of stay and the like are stored.

The characteristics table stores information about characteristics of a corresponding spot. Specifically, a time slot, a day of the week, the spot information and the like are stored. The characteristics table is generated for each of the plurality of spots. The characteristics table for a spot is associated with each record in the spot table.

By referring to these information pieces, the spot information about a specific spot and for a specific time slot may be acquired. For example, spot information (such as the level of crowdedness) for “spot with an identifier P001” and “10:00 am on a weekday” may be acquired.

In the present example, the level of crowdedness itself is included in the database, but alternatively, information for estimating the level of crowdedness may be included in the database and the level of crowdedness may be estimated as necessary.

The communication unit 103 is a communication interface for connecting the server apparatus 100 to a network. For example, the communication unit 103 includes a network interface board, and a wireless communication interface for wireless communication.

The configurations illustrated in FIG. 2 are only examples, and the illustrated functions may be partially or wholly performed by a dedicated circuit. Furthermore, programs may be stored or executed by a combination of main memory and auxiliary memory other than those illustrated.

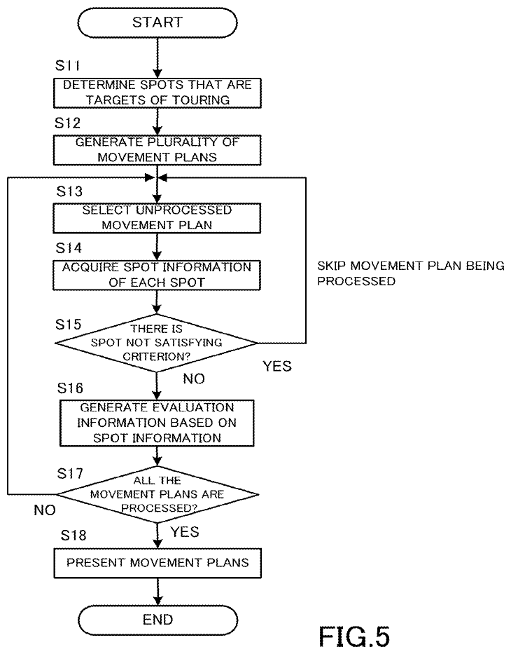

FIG. 5 is a flowchart illustrating a process that is performed by the server apparatus 100. The flowchart illustrated in FIG. 5 is performed in a case where a generation request for a movement plan is received from the user terminal 200. The request includes a target area, a departure point, a departure date/time, a spot visit to which is desired, a genre of spot visit to which is desired, a returning time and the like, for example.

First, in step S11, the plan generation unit 1011 determines a plurality of spots that are targets of touring. In the present step, a plurality of spots matching the request are determined. For example, in the present step, a plurality of spots that are within a predetermined range of the departure point and that can be toured by the returning time are selected. Additionally, in the case where a wish of the user (such as a specified spot or genre) is included in the request, spots may be selected based preferentially on the wish.

Additionally, in the present step, a plurality of patterns of combinations of spots may be generated. For example, a genre (restaurant, temple, amusement facility, etc.) is associated with each of a plurality of spots, and it is sometimes not adequate to successively visit spots of a same genre. For example, facilities that serve lunch should not be visited successively. Accordingly, a plurality of patterns may be generated such that genres of spots are distributed.

In step S12, the plan generation unit 1011 generates a plurality of movement plans for touring around the selected spots. The movement plan may be determined in any way as long as a plurality of spots may be toured in a reasonable manner. When an unreasonable (clearly wasteful) plan is generated, such a plan may be automatically skipped.

The movement plan may be generated by referring to information about transport means between spots. For example, railway/bus route maps, operation timetables, road maps and the like may be acquired, and a movement schedule between spots may be generated by a known route search method. The generated movement plan includes information about an arrival time at each spot and transport means between spots, for example.

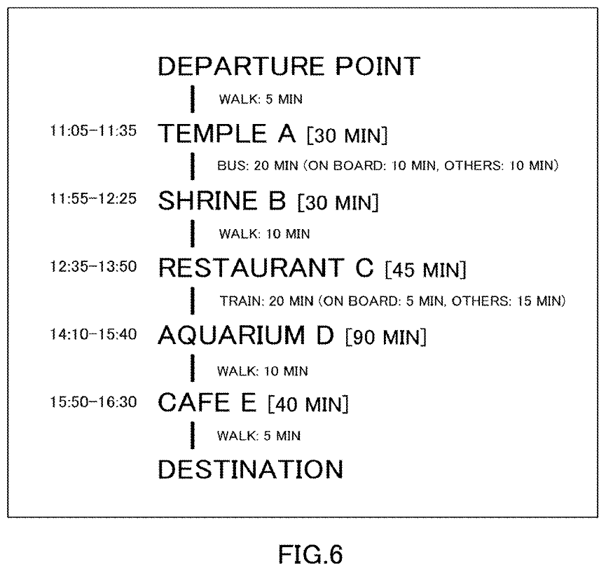

FIG. 6 is a diagram illustrating an example of the movement plan that is generated. A plurality of such movement plans are generated in the present step.

In the case where a plurality of combinations of spots are generated in step S11, a plurality of movement plans may be generated for each of the combinations.

In step S13, an unprocessed plan is selected from the plurality of movement plans that are generated.

In step S14, the information acquisition unit 1012 acquires the spot information about a plurality of spots included in the selected movement plan. For example, in the case of the example illustrated in FIG. 6, the user arrives at

Temple A at 11:05 am,

Shrine B at 11:55 am,

Restaurant C at 12:35 pm,

Aquarium D at 14:10 pm, and

Cafe E at 15:50 pm.

Accordingly, the spot information associated with the corresponding time is acquired for each of these spots. In the present example, the spot information is information about the level of crowdedness. For example, the spot information may be a numerical value indicating the level of crowdedness, an entrance wait time, a parking vacancy rate, or the like. The entrance wait time may be, for example, a direct wait time for receiving a service at the spot (such as a time from arrival at a shop to being seated), or an indirect wait time (such as an entrance wait time for a parking lot).

In step S15, the information acquisition unit 1012 determines whether or not there is a spot that does not satisfy a criterion. For example, in the case where there is a spot that is not recommended due to the entrance wait time exceeding a threshold, the movement plan that is being processed is skipped, and the process proceeds to step S13. Whether or not there is a spot that does not satisfy a criterion may be determined based on the level of satisfaction of the user that is estimated.

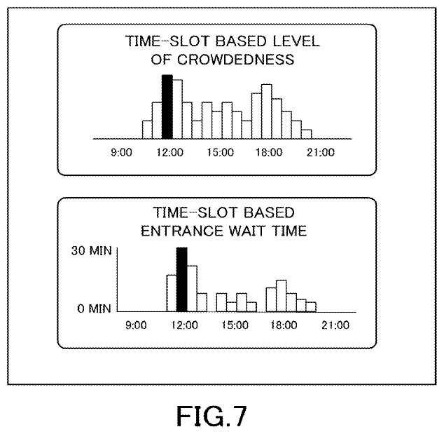

In step S16, the plan presenting unit 1013 generates evaluation information based on the spot information that is acquired. The evaluation information is information to be presented to the user, and may be an image or a graph expressing the level of crowdedness in numerical values, for example. FIG. 7 is an example of information about the level of crowdedness in different times slots that is expressed by a graph. A black part indicates the time slot of arrival of the user.

In step S17, the information acquisition unit 1012 determines whether or not processing is completed for all of the plurality of movement plans. In the case where there is a movement plan that is not yet processed, the process proceeds to step S13.

In step S18, the plan presenting unit 1013 generates and outputs a user interface for presenting the movement plans to the user.

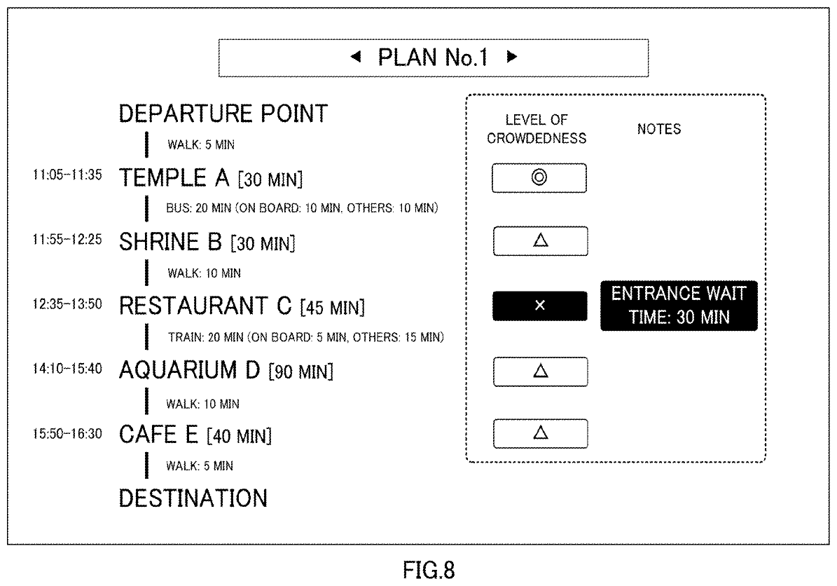

FIG. 8 is an example of the user interface that is output. In the present example, a screen indicating details of each movement plan is output. A part indicated by a dotted line is the spot information about each spot. In this case, information classifying the level of crowdedness, and a comment about a spot where the level of crowdedness is higher than a predetermined value are output. In the present example, the spot information is output in texts, but an image as illustrated in FIG. 7 may alternatively be output.

By performing an operation on the user interface screen, the user may switch between the plurality of movement plans generated in step S12 and view details thereof.

As described above, the server apparatus 100 according to the first embodiment acquires the spot information (that is, information about the level of crowdedness at the spot) for the time of arrival of the user, at the time of generating a movement plan, and outputs the same at the time of presenting the plan. According to such a configuration, the user may grasp in advance the level of crowdedness at each of a plurality of spots at the time of arrival, and may select an appropriate movement plan.

### Second Embodiment

In the first embodiment, information about the level of crowdedness is output for each spot as the spot information. By contrast, a second embodiment is an embodiment in which an image of each spot that is different based on the time slot is further provided to the user.

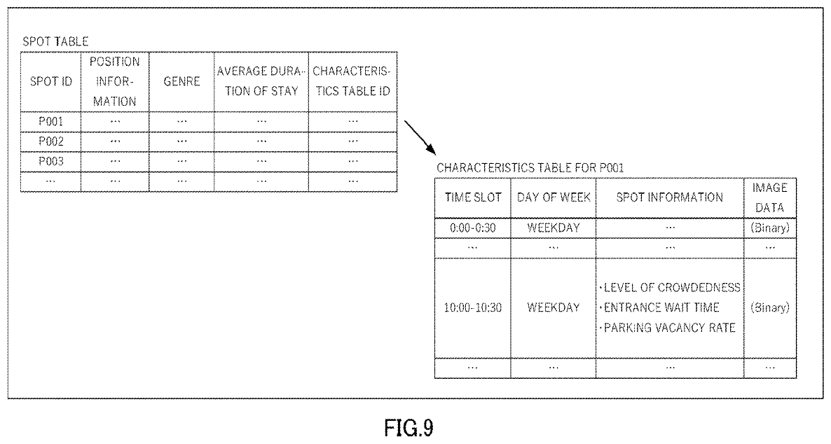

FIG. 9 is an example of the spot database 102A in the second embodiment. As illustrated, in the present embodiment, image data for each time slot is associated with the characteristics table for each spot. The image data may include an image that allows the level of crowdedness to be grasped, for example. Furthermore, in the case where a target spot is a spot that exhibits different characteristics in different time slots, such as a viewing deck or a night view spot, the image data may include an image of a scenery or a view in a corresponding time slot.

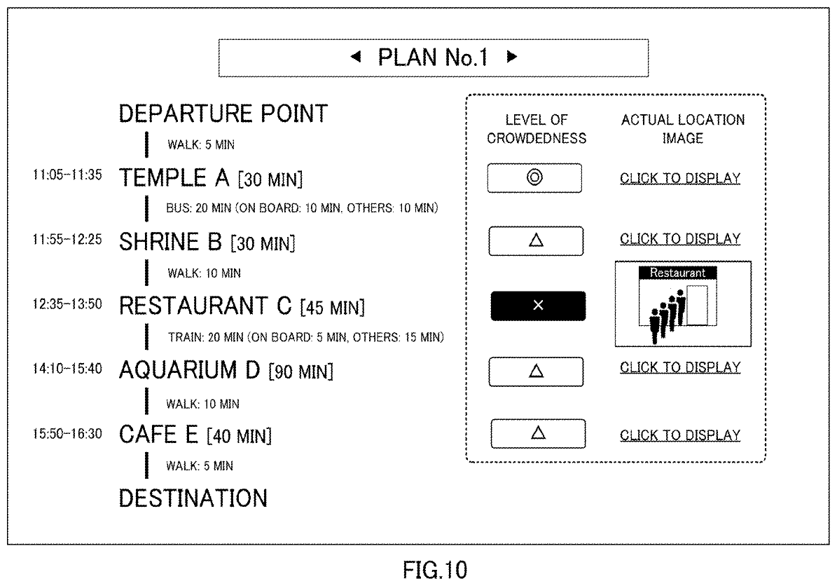

FIG. 10 is an example of an interface screen that is presented to the user in the second embodiment. In the present example, an image of an actual location in an arrival time slot is presented together with information about the level of crowdedness.

According to such a configuration, the user may grasp in advance characteristics of each of a plurality of spots at a time of visit, and may select an appropriate movement plan. For example, a determination may be made whether to visit a viewing deck during daytime or nighttime.

### Third Embodiment

A third embodiment is an embodiment in which the level of recommendation of visit that is different based on the time slot is associated with each spot, and information about the level of recommendation of visit is further provided.

Each spot may have a time slot that is suitable for visiting. For example, in the case where a target spot is a viewing deck, it may be more suitable to visit around or after sunset than in a time slot in the afternoon. Furthermore, in the case where a target spot is a cinema, it is more suitable to visit immediately before screening of a film is started than after screening is started. In the third embodiment, information is provided to the user taking such elements into account.

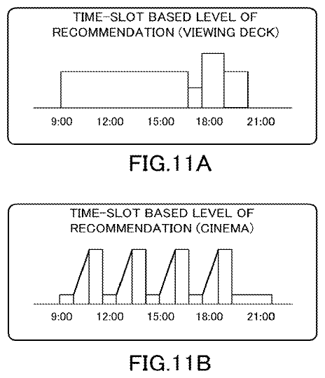

FIGS. 11A and 11B is a diagram for describing the level of recommendation of visit. FIG. 11A is an example of a case where the target spot is a viewing deck. In the present example, the level of recommendation of visit is highest for several hours after sunset. By contrast, the level of recommendation of visit is low for a time slot when sunset can be seen after a short wait.

Furthermore, FIG. 11B is an example of a case where the target spot is a cinema. In the present example, the level of recommendation of visit is the highest immediately before screening of a film is started. Furthermore, the level of recommendation of visit is low after screening is started, and the level of recommendation of visit is gradually increased toward a time of next screening.

In the third embodiment, such information about the level of recommendation of visit is stored as the spot information and is provided to the user.

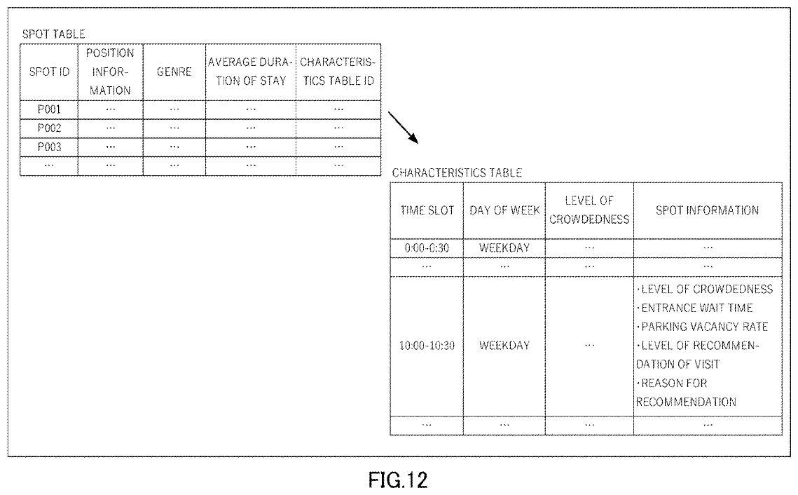

FIG. 12 is an example of the spot database 102A in the third embodiment. In the present embodiment, the level of recommendation of visit for each time slot and data indicating a reason therefor are stored as the spot information.

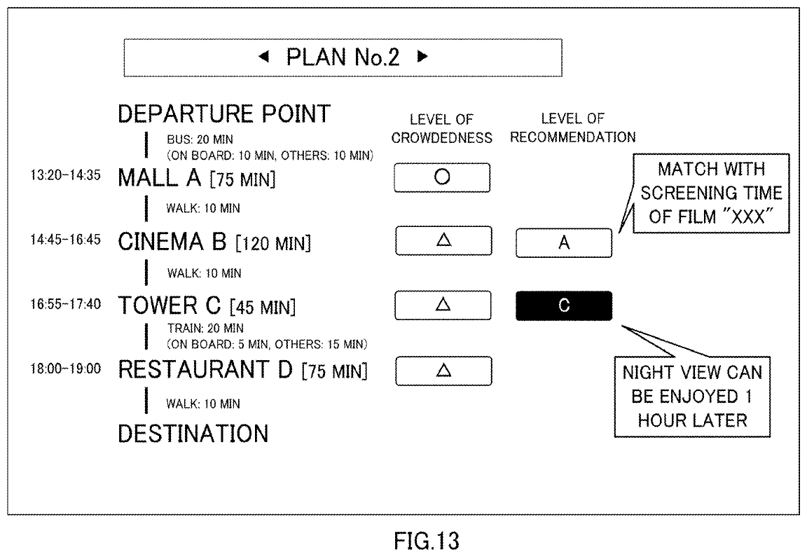

FIG. 13 is an example of an interface screen that is presented to the user in the third embodiment. In the present example, information about the level of recommendation of visit for an arrival time slot is provided together with information about the level of crowdedness. For example, a plurality of classified levels of recommendation of visit and information about reasons therefor are presented to the user.

In this manner, according to the third embodiment, the user may grasp in advance the level of recommendation for the time of visit and a reason therefor in relation to each of a plurality of spots, and may select an appropriate movement plan.

### Modifications

In the first to third embodiments, a plurality of movement plans are presented to the user and the user performs selection, but it is also possible to allow a presented movement plan to be partially changed.

For example, in the case where there is a spot for which the level of crowdedness exceeds a predetermined value, or a spot for which the level of recommendation of visit is below a predetermined value, a different spot of a same genre (an alternative spot) may be proposed instead of the above-mentioned spot. The alternative spot may be a spot that is of the same genre and that is highly evaluated by users, for example. Evaluations may be acquired from an external database, or from an external apparatus providing SNS, for example.

Whether to propose an alternative spot or not may be determined based on the level of satisfaction of the user that is estimated.

Furthermore, in the case where a higher evaluation can be obtained by shifting the time slot of visit, regeneration of the schedule itself may be proposed. For example, an operation of changing the departure time, switching the order of spots, or inserting a new spot may be enabled on the user interface.

### Other Embodiments

The embodiments described above are merely examples, and the present disclosure may be changed as appropriate within the scope of the disclosure.

For example, processes and units described in the present disclosure may be freely combined to the extent that no technical conflict exists.

Furthermore, in the description of the embodiments, in relation to the spot information, (1) information about the level of crowdedness, (2) an image of an actual location, and (3) information about the level of recommendation of visit are cited as examples, but other information pieces may also be presented as long as the information indicates the characteristics of each spot that are different based on the time slot.

For example, preference may be acquired on a per-user basis, and a comment about the degree of match with the preference may be output. For example, each user may have preference regarding the order of visit, such as “I want to eat after going to cinema”. Furthermore, there may be preference regarding the time slot of visit, such as “I want to eat by 13:00 pm even if it is crowded”.

To meet such requirements, the degree of match with the preference may be determined for each spot, and a generated comment may be presented to the user.

Furthermore, in the description of the embodiments, a user interface mainly displaying text information, as illustrated in FIG. 8, is cited as an example, but alternatively, a plurality of spots and routes may be mapped on a map and be output as an image.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium may be, for example, any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to:
generate a plurality of movement plans for touring around a plurality of spots;
acquire, for each of the plurality of spots included in each of the plurality of movement plans, spot information that is information that affects a level of satisfaction of a user visiting the spot; and
present, to the user, each of the plurality of movement plans together with the spot information about each of the plurality of spots.

2. The information processing apparatus according to claim 1, wherein
the spot information is information about characteristics of a corresponding spot that are different based on a time slot, and
the controller extracts, from the spot information, information corresponding to an arrival time, for each of the plurality of spots included in each of the plurality of movement plans, and presents the information to the user.

3. The information processing apparatus according to claim 2, further comprising
a storage configured to store each of the plurality of spots in association with the spot information.

4. The information processing apparatus according to claim 2, wherein
the spot information includes information about a level of crowdedness that is different based on a time slot, and
the controller presents, to the user, as the spot information, information indicating the level of crowdedness at a time of arrival at each of the plurality of spots.

5. The information processing apparatus according to claim 2, wherein
the spot information includes information about a wait time that is different based on a time slot, and
the controller presents, to the user, as the spot information, information indicating the wait time at a time of arrival at each of the plurality of spots.

6. The information processing apparatus according to claim 2, wherein
the spot information includes information about a level of recommendation of visit that is different based on a time slot, and
the controller presents, to the user, as the spot information, information indicating the level of recommendation of visit at a time of arrival at each of the plurality of spots.

7. The information processing apparatus according to claim 1, further comprising
a storage configured to store, for the plurality of spots, image data that is captured at each spot in each of different time slots, wherein
the controller acquires the image data corresponding to an arrival time, for each of the plurality of spots included in each of the plurality of movement plans, and further presents the image data to the user.

8. The information processing apparatus according to claim 1, wherein
the controller evaluates the plurality of spots based on preference of the user, and further presents a comment based on the evaluation to the user.

9. The information processing apparatus according to claim 1, wherein
the controller determines, based on the spot information that is acquired, that a spot for which the level of satisfaction of the user is below a predetermined value is included in at least one of the plurality of movement plans, and proposes, in relation to the spot, an alternative spot for which the level of satisfaction exceeds the predetermined value.

10. The information processing apparatus according to claim 1, wherein
the controller determines, based on the spot information that is acquired, that a spot for which the level of satisfaction of the user is below a predetermined value is included in at least one of the plurality of movement plans, and refrains from presenting a movement plan including the spot to the user.

11. An information processing method comprising:
generating a plurality of movement plans for touring around a plurality of spots;
acquiring, for each of the plurality of spots included in each of the plurality of movement plans, spot information that is information that affects a level of satisfaction of a user visiting the spot; and
presenting, to the user, each of the plurality of movement plans together with the spot information about each of the plurality of spots.

12. The information processing method according to claim 11, wherein
the spot information is information about characteristics of a corresponding spot that are different based on a time slot, and
information corresponding to an arrival time is extracted from the spot information, for each of the plurality of spots included in each of the plurality of movement plans, and presented to the user.

13. The information processing method according to claim 12, wherein
the spot information includes information about a level of crowdedness that is different based on a time slot, and
information indicating the level of crowdedness at a time of arrival at each of the plurality of spots is presented to the user as the spot information.

14. The information processing method according to claim 12, wherein
the spot information includes information about a wait time that is different based on a time slot, and
information indicating the wait time at a time of arrival at each of the plurality of spots is presented to the user as the spot information.

15. The information processing method according to claim 12, wherein
the spot information includes information about a level of recommendation of visit that is different based on a time slot, and
information indicating the level of recommendation of visit at a time of arrival at each of the plurality of spots is presented to the user as the spot information.

16. The information processing method according to claim 11, wherein
image data corresponding to an arrival time is acquired, among image data that is captured at each spot in each of different time slots, for each of the plurality of spots included in each of the plurality of movement plans, and is further presented to the user.

17. The information processing method according to claim 11, wherein
the plurality of spots are evaluated based on preference of the user, and a comment based on the evaluation is further presented to the user.

18. The information processing method according to claim 11, wherein
that a spot for which the level of satisfaction of the user is below a predetermined value is included in at least one of the plurality of movement plans is determined based on the spot information that is acquired, and an alternative spot for which the level of satisfaction exceeds the predetermined value is proposed in relation to the spot.

19. The information processing method according to claim 11, wherein
that a spot for which the level of satisfaction of the user is below a predetermined value is included in at least one of the plurality of movement plans is determined based on the spot information that is acquired, and a movement plan including the spot is prevented from being presented to the user.

20. A non-transitory computer readable storing medium recording a computer program for causing a computer to perform an information processing method according to claim 11.
